(19) United States
(12) Patent Application Publication
(10) Pub. No.: US 2025/0313757 A1
(43) Pub. Date: Oct. 9, 2025

(54) METHOD FOR PRODUCING HIGH VALUE CHEMICALS FROM FEEDSTOCK

(71) Applicants: SYNOVA RENEWABLE TECHNOLOGY B.V., Maassluis (NL); NEDERLANDSE ORGANISATIE VOOR TOEGEPAST-NATUURWETENSCHAPPELIJK ONDERZOEK TNO, The Hague (NL)

(72) Inventors: Robin Willem Rudolf ZWART, Maassluis (NL); Abraham VAN DER DRIFT, Castricum (NL); Berend Joost VREUGDENHIL, Alkmaar (NL); Alexander Jacobus GROOTJES, Alkmaar (NL)

(73) Assignees: SYNOVA RENEWABLE TECHNOLOGY B.V., Maassluis (NL); NEDERLANDSE ORGANISATIE VOOR TOEGEPAST-NATUURWETENSCHAPPELIJK ONDERZOEK TNO, The Hague (NL)

(21) Appl. No.: 18/865,720

(22) PCT Filed: May 15, 2023
(86) PCT No.: PCT/NL2023/050271

§ 371 Date: Nov. 14, 2024

(30) Foreign Application Priority Data
May 16, 2022 (NL) 2031869

(51) Int. Cl. C10B 49/22; C10B 53/02; C10B 53/07; C10B 57/16; C10L 3/10

(52) U.S. Cl. CPC C10B 49/22; C10B 53/02; C10B 53/07; C10B 57/16; C10L 3/101

(57) ABSTRACT

Method of producing high value chemicals from feedstock, wherein the feedstock is waste material or comprises waste material. A fluidised reactor system is provided comprising a pyrolysis chamber (2) and combustion chamber (12). The feedstock is input into the pyrolysis chamber and a pyrolysis process is executed at a temperature in the range of from 650 to 850° C. to obtain a product gas comprising high value chemicals.

### FIELD

The present invention relates to an improved method for producing high value chemicals from feedstock. More specifically, the present invention relates to an improved method for producing high value chemicals from waste material. More specifically, the improved method is for increasing the yield of olefins, monocyclic aromatic compounds, or combination thereof and reducing side reactions and levels of contaminants present in the product gas.

### BACKGROUND

WO2003/018723 discloses a method and device for cleaning synthesis gas obtained during gasification of biomass. The synthesis gas is passed through a saturation device and an absorption device, both of which are fed with oil. The oil is used as a scrubbing agent to remove tar from the synthesis gas.

WO2018/208163 discloses a method and device for the removal of monocyclic aromatic compounds from a gas. The gas is contacted with a washing liquid to obtain a purified gas and a spent washing liquid comprising dissolved monocyclic aromatic compounds. The spent washing liquid is stripped with steam and the monocyclic aromatic compounds are separated by condensation and further decanting.

US2020/0362248 discloses a method and device for producing olefins and aromatics through catalytic pyrolysis of polymers. Heat-forming additives are used to provide adequate heat during catalyst regeneration.

U.S. Pat. No. 10,093,860 discloses a process and apparatus for treating waste comprising mixed plastic waste. The process includes feeding the waste to a pyrolysis reactor to produce a fuel and using the fuel to run a generator to produce electricity.

WO2008/108644 and WO2014/070001 disclose a device for producing a product gas from biomass. Fuel (e.g. biomass) supplied to a riser in a reactor usually comprises 80% by weight of volatile constituents and 20% by weight of substantially solid carbon or char. Heating the biomass supplied to the riser to a temperature higher than 800° C., such as between 850-900° C., in a low-oxygen or oxygen free environment results in pyrolysis of the biomass and production of a product gas. The solid carbon and char only undergo pyrolysis to a limited extent and it is therefore necessary to combust this material in a separate combustion zone of the reactor.

It is therefore an object of aspects of the present invention to address one or more of the above-mentioned or other problems.

### SUMMARY OF THE INVENTION

In an aspect, the invention concerns a method for producing high value chemicals from feedstock, wherein the feedstock is waste material or comprises waste material, the method comprising: (a) providing a fluidised reactor system comprising a pyrolysis chamber and combustion chamber, and (b) inputting the feedstock into the pyrolysis chamber and executing a pyrolysis process at a temperature in the range of from 650 to 850° C. to obtain a product gas comprising high value chemicals.

Furthermore, all defined features for the method according to the invention equally applies to the use according to the invention, and vice versa.

The method according to the invention enables waste material to be pyrolysed at sufficiently low temperatures to provide optimised yields of high value chemicals and reduction of side products. A further advantage of the method is that the feedstock may be a mixture of biomass and plastics and is therefore cheap, by way of example the feedstock does not require intensive separation before use.

The waste material may be municipal solid waste.

The waste material is preferably biomass, biomass rich refuse-derived fuel, plastic rich refuse-derived fuel and plastics or combinations thereof. Biomass may be near 100% biogenic, biomass rich refuse-derived fuel is typically from 50 to 70% biogenic, plastic rich refuse-derived fuel is typically from 50 to 75% non-biogenic, and plastics are typically from 75 to 100% non-biogenic.

The waste material preferably comprises plastic material. The waste material may comprise from 30 to 100% of plastic by weight of the waste material. By way of example, the refuse derived fuel may comprise from 50 to 80% of plastic by weight of the total refuse derived fuel. Increasing the amount of plastics in the waste material in-turn increases the amount of high value chemicals, such as olefins.

The anthropogenic carbon present in the waste material may be from 40 to 100% by weight of the waste material, preferably from 60 to 90%.

The waste material may have a moisture content of from 5 to 30% by weight of the waste material, preferably from 10 to 25%. Providing said moisture content facilitates the feeding of plastics into the pyrolysis chamber. Providing waste material with a moisture content above 30% would reduce to the operating temperatures of the combustion chamber to an ineffective level.

Preferably, the high value chemicals in the product gas are olefins and/or monocyclic aromatic compounds. The olefins may be ethylene, propylene, C₄ olefins, C₅ olefins, C₅₊ olefins, or combinations thereof. Preferably the olefins are ethylene, propylene, C₄ olefins, C₅ olefins, or combinations thereof. Even more preferably, the olefins are ethylene, propylene, C₄ olefins, or combinations thereof. The monocyclic aromatic compounds may be benzene, toluene, styrene, ethyl benzene, xylene or combinations. More specially the monocyclic aromatic compounds may be benzene, toluene, styrene, ethyl benzene, m-xylene, p-xylene or combinations thereof. Preferably the monocyclic aromatic compounds are benzene, toluene, xylene, styrene or combinations thereof.

In a preferred embodiment the olefins are ethylene, propylene, C₄ olefins, C₅ olefins, or combinations thereof and/or the monocyclic aromatic compounds are benzene, toluene, xylene, styrene or combinations thereof. More preferably, the olefins are ethylene, propylene, C₄ or combinations thereof and/or the monocyclic aromatic compounds are benzene, toluene, xylene, or combinations thereof. Even more preferably the olefins are ethylene, propylene, or combinations thereof and/or the monocyclic aromatic compounds are benzene, toluene, xylene, or combinations thereof.

The product gas may comprise from 30 to 70% of olefins by weight of the product gas, preferably 45 to 60%. The product gas may comprise from 5 to 25% of monocyclic aromatic compounds by weight of the product gas, preferably from 10 to 20%, even more preferably from 12 to 18%.

The method may further comprise circulating bed material from the combustion chamber to the pyrolysis chamber via a transport zone, and executing the pyrolysis process and the combustion process in the bed material, wherein upon circulating the bed material sufficient heat is transferred from the combustion chamber to the pyrolysis chamber to execute the pyrolysis process. This enables heat generated in the combustion chamber to be transferred to the pyrolysis chamber via circulation of the bed material. The bed material is continuously circulated from the combustion chamber to the pyrolysis chamber preferably via a closed system or loop. Put another way, the bed material is continuously circulated preferably via a closed loop between the combustion chamber and the pyrolysis chamber.

The temperature difference between the combustion chamber and the pyrolysis chamber may be increased by decreasing the circulation rate of the bed material. This allows for higher combustion temperatures and thereby enables low temperature to be maintained in the pyrolysis chamber. A further advantage is the prevention or minimisation of over-cracking of the polymers which increases the yield of the monomer products. Increasing the circulation rate may also prevent or minimise side reactions. The circulation rate of the bed material may be from 10 to 100 kg bed material circulated per kg feedstock, more preferably from 20 to 60 kg per kg.

The temperature difference between the combustion chamber and the pyrolysis chamber may be decreased by increasing the circulation rate of the bed material. This enables higher temperatures to be achieved in the pyrolysis chamber. The circulation rate of the bed material may be in the range of 10 to 100 kg bed material circulated per kg feedstock, more preferably 20 to 60 kg per kg.

Furthermore, providing heat directly via the hot bed material results in the feedstock being exposed to substantially uniform temperatures in the pyrolysis chamber as all the heat, or substantially all the heat for the pyrolysis process, is provided by the bed material. In contrast, conventional heating techniques that provide heat indirectly through the wall of the pyrolysis reactor container or via internal heat tubes results in temperature hot spots and high surface temperatures. These temperature hot spots and high surface temperatures result in over-cracking of feedstock. For example, the temperature at or near the chamber wall of conventional naphtha crackers can easily be 200° C. higher than the temperature needed for the cracking of naphtha and naphtha gases. Thus, providing heat via the bed material prevents or minimises side reactions and consequently the yield of high value chemicals is increased.

The bed material is preferably sand, such as crystal quartz sand. Alternatively, the bed material may be olivine or dolomite. Olivine and dolomite may exhibit catalytic activity. The hot bed material may also comprise further components. Clay material may be added to the bed material to avoid agglomeration of particles. Typically high porosity clay minerals are used, for example halloysite, kaolinite, sepiolite, or combinations thereof.

The pyrolysis process may be executed at a temperature in the range of from 700 to 800° C., preferably executed at a temperature in the range of from 730 to 770° C. Executing the pyrolysis process between 730 to 770° C. provides large amounts of olefins, and reduces the amounts of heavy hydrocarbon fractions, such as heavy tar fractions. The pyrolysis process temperature is also chosen depending on the type of feed used, i.e. the temperature at which the polymers depolymerise.

In the combustion chamber the combustion process is executed at a higher temperature than the pyrolysis process. In the combustion chamber the combustion process may be executed at a temperature in the range of from 30 to 130° C. higher than the pyrolysis process, preferably at a temperature in the range of from 50 to 110° C. For example, the pyrolysis process is executed at a temperature in the range of from 650 to 800° C. and the combustion process is executed at a temperature in the range of from 30 to 130° C. higher than the pyrolysis process. By way of further example, the pyrolysis process is executed at a temperature in the range of from 730 to 770° C. and the combustion process is executed at at a temperature in the range of from 50 to 110° C. higher than the pyrolysis process.

The method may further comprise (c) transferring the product gas into a product recovery unit and isolating the high value chemicals. Preferably, the method further comprises transferring the product gas from the pyrolysis chamber to a tar removal system prior to being subjected to step (c) to remove one or more tar fractions from the product gas.

The tar removal system may comprise an absorption unit to remove light hydrocarbon fractions from the product gas, such as light tar fractions. A portion of the light hydrocarbon/tar fractions may be transferred to the combustion chamber. The tar removal system may comprise a quench unit to remove heavy hydrocarbon/tar fractions from the product gas, such as heavy tar fractions.

The product gas is preferably quenched via a quenching medium, typically oil, at a temperature in the range of from 50 to 95° C., preferably 60 to 90° C., more preferably 60 to 85° C. In one embodiment, the quenching is performed at such a temperature and at a pressure in the range of 0.8-2.0 bar, preferably in the range of 1.0-1.5 bar.

In a preferred embodiment the product gas is quenched via a quenching medium, typically oil, at a temperature in the range of from 50 to 95° C. (at atmospheric pressure, i.e. 1 bar) preferably 60 to 90° C. (at atmospheric pressure, i.e. 1 bar), more preferably 60 to 85° C. (at atmospheric pressure, i.e. 1 bar). In an alternative embodiment the product gas is quenched via a quenching medium, typically oil, at a temperature in the range of from 55 to 95° C. (at 1.3 bar), preferably 65 to 85° C. (at 1.3 bar).

The quenching medium typically cools the product gas to the water dewpoint temperature, which is typically in the range of from 50 to 95° C., preferably 60 to 90° C., more preferably 60 to 85° C. As the skilled person appreciated, the water dewpoint temperature may vary depending on pressure. Preferably, the pressure in this context is in the range of 0.8-2.0 bar, more preferably in the range of 1.0-1.5 bar. In a preferred embodiment the quenching medium is used to cool the product gas to a water dewpoint temperature from 50 to 95° C. (at atm), preferably 60 to 90° C. (at atmospheric pressure, i.e. 1 bar), more preferably 60 to 85° C. (at atmospheric pressure, i.e. 1 bar). In an alternative embodiment the quenching medium is used to cool the product gas to a water dewpoint temperature from 55 to 95° C. (at 1.3 bar), preferably 65 to 85° C. (at 1.3 bar).

Quenching is performed by contacting the product gas with the quenching medium, during which compounds may be removed from the product gas and dissolved in the quenching medium, which may lead to an increase in the viscosity of the quenching medium. The quenching medium after quenching may also be referred to as the spent quenching medium.

The spent quenching medium obtained after quenching may have a viscosity in the range of from 40 to 200 cP, preferably from 80 to 160 cP. Such viscosities are ideal for reusing the quenching medium, since any compound dissolved therein during the quenching is readily removed from the spent quenching medium.

The skilled person is able to determine a suitable way to measure the viscosity, either online or offline. In the context of the present invention, viscosity measurements are determined offline using samples via torque measurement on a Brookfield Ametek rheometer analyser (measured in centipoise, cP) in a temperature range of from 50 to 95° C. Typically, the viscosity is measured 40 at the temperature and pressure at which the quenching is performed.

A portion of the heavy hydrocarbon/tar fractions may be transferred to the combustion chamber so that the heavy hydrocarbon/tar fractions are used as a primary energy source in the pyrolysis process. This advantageously prevents or limits the need to rely on an external energy source such as natural gas. Preferably, the tar removal system comprises the absorption unit and the quench unit. The quench unit may also be used to remove particles. A further advantage of executing the pyrolysis reaction at a temperature from 700 to 800° C. is that sufficient amounts of heavy tars are produced in order to maintain an appropriate oil viscosity.

The class 1 to 5 tars are defined by the number of aromatic rings present in the tar, with class 1 tars consisting of compounds with one aromatic ring, class 2 tars consisting of compounds with two aromatic rings, class 3 tars consisting of compounds with three aromatic rings, class 4 tars consisting of compounds with four aromatic rings, and class 5 tars consisting of compounds with five or more aromatic rings. For example, naphthalene and fluorene are both class 2 tars as they contain two aromatic rings (benzene rings).

Tas classes 1 and 2 are typically seen as light tars, whereas tar classes 4 and 5 as heavy tars. Tars of class 3 can be considered light or heavy tars. Light class 3 tar fractions are tar fractions that are non-condensable in the tar removal system and heavy class 3 tar fractions are tar fractions that are condensable in the tar removal system.

Class 1 (i.e. benzene to cresol) have viscosities of 0-30 cP; Class 2 (i.e. naphthalene to fluorene) have viscosities of 10-20 cP; Class 3 (i.e. phenanthrene to pyrene) have viscosities of 30-90 cP; Class 4 (i.e. benzoanthracene to benzofluoranthene) have viscosities of 75-285 cP; and Class 5 (i.e. benzopyrene to coronene) have viscosities of 285-715 cP. Performing the pyrolysis reaction at a temperature from 700 to 800° C. ensures that sufficient amount of class 3 to 5 tars is collected to provide a suitable tar: dust ratio. Preferably, more Class 3-4 tars are collected than Class 5 tars so that the viscosity is not too high. The term light hydrocarbons/tars may be taken to include methane and olefins and/or the tars defined in classes 1, 2 and 3 (light tars of class 3). The term heavy hydrocarbons/tars may be taken to include the tars defined in classes 3 (heavy tars of class 3), 4 and 5.

The heavy tars are typically those that condense when the product gas is being cooled from the temperature at which the pyrolysis process is performed to a temperature in the order of the water dewpoint of the product gas. This typically occurs during a tar removal step. Light tars remain gaseous at such conditions.

Preferably the method further comprises transferring the product gas from the pyrolysis chamber to a tar removal system to remove one or more tar fractions from the product gas. Herein, typically the heavy tars are removed from the product gas.

The product gas transferred to the tar removal system preferably comprises class 3-5 heavy tar fractions, the content of class 3-4 being greater than the content of class 5 by weight of the total class 3-5 heavy tar fractions.

The product gas transferred to the tar removal system preferably comprises by weight of the total class 3-5 heavy tar fractions: (i) from 50 to 80% class 3 heavy tars, (ii) from 10 to 40% class 4 heavy tars and (iii) 10% or less class 5 heavy tars. Or put another way the product gas transferred to the tar removal system preferably comprises from 50 to 80% class 3 heavy tars by weight of the total class 3-5 heavy tar fractions, from 10 to 40% class 4 heavy tars by weight of the total class 3-5 heavy tar fractions and 10% or less class 5 heavy tars by weight of the total class 3-5 heavy tar fractions.

The product gas transferred to the tar removal system preferably comprises from 20 to 30 g/Nm³ of class 3-5 heavy tars.

The product gas transferred to the tar removal system preferably comprises a ratio of dust to class 3-5 heavy tars from 1:99 to 10:90.

The product gas transferred to the tar removal system preferably comprises from 0 to 2 g/Nm³ of dust.

The gas may also be transferred into a particulate removal unit (such as a cyclone) before being transferred to the tar removal system. The tar removal system may comprise an absorption unit to remove light hydrocarbon/tar fractions from the product gas, such as light tar fractions. Preferably, the tar removal system may comprise an absorption unit to remove light hydrocarbon/tar fractions from the product gas, such as light tar fractions, and dust.

The absorption unit preferably comprises an absorption column and a stripper column in communication with each other to allow the continuous flow of scrubbing agent between the columns. The scrubbing may occur through either a co-current mode or a counter-current mode to remove impurities, such as tar, from the gas. The scrubbing agent may be mineral oil or synthetic oil. For example paraffinic oil or an organic aryl polysiloxane oil, preferably an organic aryl polysiloxane oil.

The stripping agent used in the stripper column may be hot air, steam, nitrogen, carbon dioxide, boiler flue gas, or mixtures thereof, preferably hot air. The flowrate of the hot air into the stripper column may be from 50 to 200% of the product gas flow, preferably 100 to 200%. These flowrates have in case of using air the advantage of reducing the risk of operating above the maximum allowable level of tars as of explosion limits within the stripper gas. The stripping agent may be combustion air for the combustion chamber. The stripping column and stripping agent enable the scrubbing agent to be reused in the absorption column.

The quench unit preferably comprises a quench column adapted to receive the product gas from the pyrolysis chamber. Optionally, the quench unit may comprise a wet electrostatic precipitator connected to the quench column. The wet electrostatic precipitator is adapted to remove aerosols from the product gas.

Fluidisation gas may be transferred into the transport zone to control the circulation rate of the bed material. Fluidisation gas may be transferred into the transport zone at more than one region. Preferably the temperature difference between the combustion chamber and the pyrolysis chamber is increased or decreased by changing the ratio of fluidisation gas transferred into a first region of the transport zone relative to a second region of the transport zone. In a preferred embodiment the transport zone comprises a first region to allow the downflow of bed material from the combustion chamber and a second region to allow the upflow of bed material to the pyrolysis chamber. The fluidisation gas may be transferred into an upstream portion of the second region and into a downstream portion of the second region. The term upstream portion and downstream potion is taken to indicate the direction of flow of the bed material through the fluidised reactor system. Put another way, the bed material is circulated from the first region into the upstream portion and subsequently circulated into the downstream portion before being transferred to the pyrolysis chamber. Fluidisation gas may be transferred into the pyrolysis chamber to control the circulation rate of the bed material. The circulation rate of the bed material may by increased or decreased by altering the amount of fluidisation gas transferred into the transport zone and/or the pyrolysis chamber. The associated advantages of increasing and decreasing the circulation rate of the bed material is discussed above. The circulation rate of the bed material may by increased or decreased by altering the amount of fluidisation gas transferred into more than one region of the transport zone. Thus, changing the amount of fluidisation gas can decrease or increase the temperature difference between the combustion chamber and pyrolysis chamber by increasing or decreasing the circulation rate of the bed material, as described above. Preferably, fluidisation gas is only transferred into the second region of the transport zone, or put another way no fluidisation gas is transferred into the first region of the transport zone.

In a preferred embodiment the circulation rate of the bed material is decreased by adding more fluidisation gas into the downstream portion of the second region than the upstream portion of the second region. Here the ratio of fluidisation gas added to the upstream portion relative to the downstream portion is 1:1-6, typically 1:1.5-4. The circulation rate of the bed material is increased by adding less fluidisation gas into the downstream portion of the second region than the upstream portion of the second region. Here the ratio of fluidisation gas added to the upstream portion relative to the downstream portion is 1-6:1, typically 1.5-4:1. Redistributing the fluidisation gas so that more fluidisation gas is provided in the upstream portion than the downstream portion in-turn increases the flow rate of the hot bed material and consequently reduces the temperature difference from the combustion chamber to the pyrolysis chamber. Therefore, said redistribution of fluidisation gas increases the high value chemical yield and reduces or prevents side products.

In a further preferred embodiment, the circulation rate of the bed material is decreased by adding more fluidisation gas into the downstream portion of the second region and/or the pyrolysis chamber than the upstream portion of the second region. Here the ratio of fluidisation gas added to the upstream portion and/or the pyrolysis chamber relative to the downstream portion is 1:1-6, typically 1:1.5-4. The circulation rate of the bed material is increased by adding less fluidisation gas into the downstream portion of the second region and/or the pyrolysis chamber than the upstream portion of the second region. Here the ratio of fluidisation gas added to the upstream portion relative to the downstream portion 35 and/or the pyrolysis chamber is 1-6:1, typically 1.5-4:1.

Fluidisation gas may also be transferred into the first region. This facilitates circulation of bed material to the pyrolysis chamber. A further advantage is that it prevents or reduces the flow of flue gas into the pyrolysis chamber. This is important as flue gas comprises contaminants such as O₂ and NOₓ.

The fluidised reactor system therefore allows different amounts of fluidisation gas to be added to the transport zone and/or pyrolysis chamber and thereby control the transfer rate during operation. A further advantage of providing more than one region to add fluidisation gas is in case one region becomes blocked or partially blocked.

The fluidised reactor system therefore allows different amounts of fluidisation gas to be added to the transport zone and/or pyrolysis chamber and thereby control the transfer rate during operation. A further advantage of providing fluidization gas to more than one region is that in case a region becomes blocked or partially blocked the resulting reduction in transport of bed material can be overcome without modifying or cleaning the reactor.

The fluidisation gas may be transferred from the stripper column and/or an external source. Preferably the fluidisation gas to the pyrolysis chamber is from an external source and the fluidisation gas to the combustion chamber is from the stripper column. Preferably, the fluidisation gas transported into the transport chamber and/or pyrolysis chamber is steam. These flowrates have the advantages of reducing secondary polymerisation reactions of olefins and avoiding or limiting the formation of soot and/or high molecular weight hydrocarbons/tars.

The velocity of the fluidisation gas in the second region of the transport zone may be from 0.5 to 3 m/s, preferably from 1 to 2.5 m/s, even more preferably 2 m/s. The velocity of the fluidisation gas in the upstream portion and/or the downstream portion of the second region of the transport zone may be from 0.5 to 3 m/s, preferably from 1 to 2.5 m/s, even more preferably 2 m/s. This velocity range allows for movement of the bed material by actually fluidising the bed material.

The velocity of the fluidisation gas in the pyrolysis chamber may be from 5 to 8.5 m/s, preferably from 5.5 to 7.5 m/s. These velocity ranges allow for transport of the bed material through the pyrolysis chamber. A further advantage of these velocity ranges is that they enable the bed material to be blown out of the pyrolysis chamber and circulated into the combustion chamber.

The velocity of the fluidisation gas is dependent on the density of the fluidisation gas and on the particle size of the bed material. Generally the particle size has greater influence on the required viscosity of the fluidisation gas.

The bed material may have a dp50 of from 240 to 280 μm, preferably 260 μm. Average particle sizes are determined using laser diffraction particle size analysis, for example using a Malvern Mastersizer.

The density of the fluidisation gas in the transport zone may be from 0.9 to 1.1 kg/Nm³, preferably 1.0 kg/Nm³. The density of the fluidisation gas in the upstream portion and/or the downstream portion of the second region of the transport zone may be from 0.9 to 1.1 kg/Nm³, preferably 1.0 kg/Nm³. The density of the fluidised bed material in the transport zone may be from 900 to 1100 kg/m³, preferably 1000 kg/m³. The density of the fluidised bed material in the upstream portion and/or the downstream portion of the second region of the transport zone may be from 900 to 1100 kg/m³, preferably 1000 kg/m³.

In an embodiment, the velocity of the fluidisation gas in the upstream portion and/or the downstream portion of the second region of the transport zone may be from 0.5 to 3 m/s, preferably from 1 to 2.5 m/s, even more preferably 2 m/s; the bed material has a dp50 of from 240 to 280 μm, preferably 260 μm; and the density of the fluidisation gas in the upstream portion and/or the downstream portion of the second region of the transport zone may be from 0.9 to 1.1 kg/Nm³, preferably 1.0 kg/Nm³.

The velocity of the bed material in the first region may be from 0.05 to 0.15 m/s, preferably 0.1 m/s. The density of the bed material may be from 1440 to 1760 kg/m³, preferably 1600 kg/m³.

In an upper portion (downstream portion) and/or lower (upstream portion), of the pyrolysis chamber the velocity of the fluidisation gas may be from 5 to 8.5 m/s, preferably from 5.5 to 7.5 m/s. The density of the fluidised bed material in the upper portion and/or lower portion of the pyrolysis chamber may be from 90 to 110 kg/m³, preferably 100 kg/m³. The density of the fluidisation gas in the upper portion and/or lower portion of the pyrolysis chamber may be from 0.9 to 1.1 kg/Nm³, preferably 1.0 kg/Nm³.

The fluidisation gas may be suitably referred to as non-condensable gas, combustion air or energy source when being used or transferred to a part of the fluidised reactor system that does not use the gas or energy source as a fluidising agent, for example when the fluidisation agent is transferred from the product recovery unit to the combustion chamber. The energy source may be a gas, liquid or solid. The non-condensable gas may comprise CO, H₂, CH₄, fractions of N₂, C₂ and/or C₃ olefins, or combinations thereof. The non-condensable gas may be a fuel gas. The energy source may comprise fossil fuel, solid biomass, waste feedstock, hydrocarbon condensate from the product recovery unit, or combinations thereof. Preferably the fluidisation gas is gas produced from the product gas of the pyrolysis process or steam. More preferably the fluidisation gas is steam. Even more preferably the fluidisation gas for the transport zone is steam. When the fluidisation gas is produced from the product gas, then the following step may apply: the product gas produced in the pyrolysis chamber may be transferred to the product recovery unit and the separated fluidisation gas may be recycled back into the pyrolyse chamber and/or transferred to the transport zone. Preferably, the fluidisation gas for the combustion chamber is air. An advantage of transferring the fluidisation gas into the combustion chamber is that the fluidisation gas may act as an energy source

The method may further comprise isolating tail gas or off gas from the product gas. Preferably the tail gas or off gas is obtained following cryogenic treatment. The method may also comprise transferring at least a portion of the tail gas or off gas to the combustion chamber. Advantageously the tail gas or off gas may be used as an energy source for the combustion chamber. The tail gas or off gas may also be used to replace the tars as an energy source for the combustion chamber so that chemicals can be isolated from the tars or alternatively so that the tars can be used as a source for carbon black production. The term tail gas or off gas may be taken to mean non-condensable gas. The tail gas or off typically comprises CO, H₂, CH₄ and between 10-20% CO₂. Typical amounts of CO, H₂, CH₄ are provided in Table 1.

At least a portion of the tail gas or off gas may be used for the production of chemicals, preferably hydrogen, CO and/or olefins are used for the production of chemicals. By way of example hydrogen may be recovered from the tail gas or off gas through use of membranes. The tail gas or off gas may also be catalytically converted to fuels such as synthetic natural gas or methanol, the latter providing the option to further increase the yield of olefins by applying methanol-to-olefins (MtO) synthesis processes.

An advantage of transferring a portion of light tar fractions to the freeboard of the combustion chamber is that the operating temperatures of the combustion chamber and pyrolysis chamber are reduced. The non-condensable gas, combustion air or energy source may also comprise steam or water moisture. The non-condensable gas, combustion air or energy source may comprise 5 to 10% steam or moisture by weight of non-condensable gas, combustion air or energy source. This amount of steam or moisture is required for stripping the tar fractions from the scrubbing agent in the stripping column in sufficient quantities. A further advantage of transferring non-condensable gas, combustion air or an energy source comprising 5 to 10% steam or moisture by weight of non-condensable gas, combustion air or energy source into the combustion chamber is that the operating temperature of the pyrolysis chamber is reduced.

The fluidisation gas transported into the combustion chamber for the purpose of fluidisation may be combustion air, for example directed via the absorption unit or more specifically from the stripper column. Alternatively, or in addition to, fluidisation gas may be transferred into the combustion chamber from the product recovery unit and/or an external source.

The feedstock may comprise from 5 to 30% water originating from the waste material and/or separately added to the feedstock, preferably 5 to 15%, even more preferably from 5 to 10%. Water may be added separately to the feedstock to arrive at an amount of 5 to 30% water if the waste material contains insufficient water.

Preferably, wastewater from the product recovery unit is transferred into the combustion chamber. The amount of water used may be dependent on the amount of plastic in the feedstock. An associated advantage of providing feedstock with a water content as described is to maintain the operating temperature of the feeding screw at a suitable level to avoid decomposition of the waste material within the feeding screw.

Preferably the method further comprises transferring a fraction produced by the pyrolysis process into the combustion chamber and executing a combustion process in the bed material to provide a flue gas. The fraction may comprise unconverted char.

The method may further comprise transferring the flue gas to a heat recovery system.

The fluidised reactor system may further comprise a downcomer to allow bed material to circulate from the pyrolysis chamber to the combustion chamber. The downcomer may be positioned coaxially around the pyrolysis chamber. In use, the bed material flows over an upper portion of the pyrolysis chamber into the downcomer and then circulates into the combustion chamber. A layer of bed material therefore always surrounds the pyrolysis chamber and acts as an insulation layer between the walls of the pyrolysis chamber and the downcomer. This reduces radial transfer of heat from the combustion chamber to the pyrolysis chamber and thereby prevents the walls of pyrolysis chamber from being heated to high temperatures which could result in further cracking.

Fluidisation gas may also be added into the downcomer. This helps prevent the flow of product gas, via the bed material, into the combustion chamber and thereby increases the yield of product gas.

The fluidisation gas and/or non-condensable gas/energy source velocities are controlled by flow transmitters within the fluidised reactor system.

The combustion chamber may be arranged to surround at least a portion of the pyrolysis chamber. The pyrolysis chamber may be arranged centrally or substantially centrally within the combustion chamber.

The method may further comprise transferring the product gas from the pyrolysis chamber to a particulate removal unit (for example comprising a cyclone) prior to being transferred to the product recovery unit or the tar removal system. Preferably, further comprising transferring the product gas from the pyrolysis chamber to a particulate removal unit, such as a cyclone, prior to being transferred to the tar removal system to remove dust from the product gas.

In an embodiment the invention concerns a use of a fluidised reactor system comprising a pyrolysis chamber, a combustion chamber, and bed material that circulates from the combustion chamber to the pyrolysis chamber via a transport zone, for depolymerising polymers into one or more monomers.

A pyrolysis process may be executed at a temperature in the range of from 400 to 750° C. in the bed material to obtain the depolymerised polymer product gas comprising the monomers.

A temperature difference between the combustion chamber and the pyrolysis chamber may be regulated by changing the ratio of fluidisation gas transferred into a first region of the transport zone relative to a second region of the transport zone.

A temperature difference between the combustion chamber and the pyrolysis chamber may be increased or decreased by changing the circulation rate of the bed material.

### BRIEF DESCRIPTION OF DRAWINGS

FIG. 1 shows a schematic view of a reactor system according to an embodiment of the present invention.

### DESCRIPTION OF EMBODIMENTS

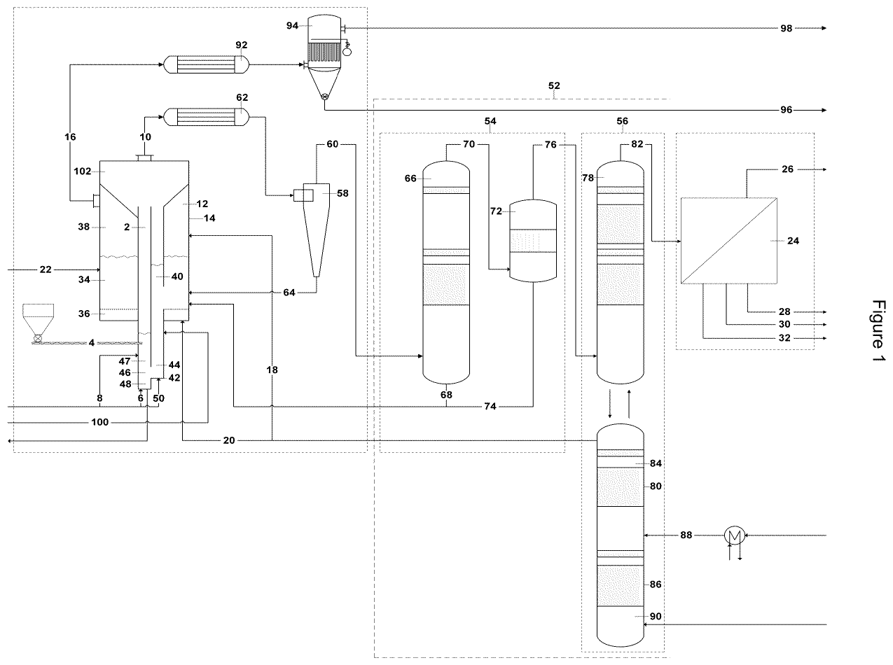

In an embodiment shown in the schematic view of FIG. 1, a fluidised reactor system is provided for producing high value chemicals from a feedstock, wherein the feedstock is waste material or comprises waste material. The waste material is biomass, biomass rich refuse-derived fuel, plastic rich refuse-derived fuel and plastics or combinations thereof. The reactor system comprises a pyrolysis chamber 2 comprising a feedstock input 4 (which may comprise a feedstock silo), a first fluidisation gas input 6, a second fluidisation gas input 8, and a product gas output 10. A combustion chamber 12, delimited by a wall 14, at least partially surrounds the pyrolysis chamber 2 and is connected to a flue gas output 16, a first combustion air input 20 and a second combustion air gas input 18. The combustion chamber 12 is also connected to a water input 22, which is preferably wastewater from a product recovery unit 24. The product recovery unit 24 comprises a tail gas output 26 and one or more product outputs, such as a C₂ outlet 28, a C₃ outlet 30 and a C₄ outlet 32. The combustion chamber 12 comprises a fluidised bed zone 34, an air chamber 36 located beneath the fluidised bed zone 34, and a freeboard 38 located above the fluidised bed zone 34. A downcomer 40 is also provided to allow the bed material, char and fractions of the product gas (typically 1 to 2% by weight of the total weight of the product gas) to be transferred from the pyrolysis chamber 2 to the combustion chamber 12. The pyrolysis chamber 2 and the combustion chamber 12 are connected via a transport zone 42. The transport zone 42 comprises a first region 44 to allow the downflow of bed material from the combustion chamber 12 and a second region 46 to allow the upflow of bed material to the pyrolysis chamber 2. The second region 46 comprises a downstream portion 47 and an upstream portion 48. The first region 44 is connected to a third fluidisation gas input 50 for providing fluidisation gas to the pyrolysis chamber 2 via the transport zone 42. The pyrolysis chamber 2 is connected to the first fluidisation gas input 6 via the transport zone 42. Or put another way, the first fluidisation gas input 6 is connected to the upstream portion 48 of the second region 46 to allow the flow of fluidisation fluid into the second region 46 so that the fluidisation liquid is transferred to the pyrolysis chamber 2. The pyrolysis chamber 2 may be connected to the second fluidisation gas input 8 via the transport zone 42. Or put another way, the second fluidisation gas input 8 is connected to the downstream portion 47 of the second region 46 to allow the flow of fluidisation fluid into the second region 46 so that the fluidisation liquid is transferred to the pyrolysis chamber 2. Alternatively, the second fluidisation gas input 8 is directly connected to the pyrolysis chamber 2 to allow the flow of fluidisation fluid directly into the pyrolysis chamber 2. The second region 46 may be part of the pyrolysis chamber 2. The transport zone 42 is for circulating bed material between the combustion chamber 12 and the pyrolysis chamber 2. The product gas output 10 may be directly connected to a tar removal system 52 (which may comprise a quench unit 54 and/or an absorption unit 56). Alternatively, the product gas output 10 may be connected to a particulate removal unit 58 (such as a cyclone). The particulate removal unit 58 comprises a product gas output 60 connected to the tar removal system 52. The product gas output 10 may be connected to a cooler 62 which in turn is connected to the particulate removal unit 58. The particulate removal unit 58 further comprises an ash gas outlet 64 for transferring ash to the fluidised bed zone 34 of the combustion chamber 12. Preferably the quench unit 54 comprises a quench column 66 which is adapted to receive the product gas from the pyrolysis chamber 2. The quench column 66 comprises an ash and tar output 68 and a quenched product gas output 70. The product gas output 70 is connected to a wet electrostatic precipitator 72. The wet electrostatic precipitator 72 comprises an aerosol liquid output 74 connected to an oil circulation loop (not shown) of the quench column 66, wherein the oil circulation loop is connected to the combustion chamber 12. The wet electrostatic precipitator 72 further comprises a de-aerosoled product gas output 76 connected to the absorption unit 56. The absorption unit 56 comprises an absorption column 78 connected to the de-aerosoled product gas output 76 and a stripper column 80 in communication with the absorption column 78. The absorption column 78 comprises a product gas output 82 connected to the product recovery unit 24. The stripper column 80 comprises a stripping section 84 and a deaeration section 86. The stripping section 84 is in communication with the first combustion air input 20 to the freeboard 38 and the combustion air input 20 to the combustion bed. The deaeration section 86 comprises a deaerating agent input 90 for deaerating the scrubbing agent. Preferably, the stripping section 84 uses air and the deaeration section 86 uses steam. Alternatively, the stripper column 80 may only comprise a stripping section which uses steam. When only a stripping section is present, the combustion air is provided to the combustion chamber via a separate source and not by the stripper column 80.

The combustion air inputs 18 and 20 are arranged to provide an additional source of combustible gas, i.e. tars from the stripper column 80, to the combustion chamber 34 to heat the bed material and the freeboard 38 of the combustion chamber 12. The combustion gas transferred via combustion air input 20 also acts as a fluidization gas for the bed material. The flue gas output 16 of the combustion chamber 12 may be connected to a gas cooler 92 which in turn is connected to a gas filter 94 for fly ash removal. The gas filter 94 comprises a cleaned flue gas output 98 and a fly ash output 96. The first region 44 of the transport zone 42 may comprise a steam input 100 for stripping flue gas, in particular O₂ and Nox, from the circulating bed material and thereby removing these contaminants for the product gas before entry into the product recovery unit 24.

In use, the bed material (preferably sand, such as crystal quartz sand or alternatively olivine or dolomite) is continuously circulated between the pyrolysis chamber 2 and the combustion chamber 12 via the downcomer 40 and the transport zone 42. The feedstock is introduced into the pyrolysis chamber 2, via the feedstock input 4, and a pyrolysis process is executed at a temperature in the range of from 650 to 850° C. in the bed material to obtain a product gas comprising high value chemicals and a side-fraction. The side-fraction is transferred from the pyrolysis chamber 2 to the combustion chamber 12 (via a settling chamber 102 and the downcomer 40) by the bed material and combusted in the fluidised bed zone 34 at a temperature from 30 to 130° C. higher than the pyrolysis process in the presence of air to provide a flue gas which is used to heat the bed material in the combustion chamber 12. The flue gas then exits the combustion chamber 12 via the freeboard 38. The flue gas comprises primarily one or more of N₂, CO₂ and H₂O. The flue gas may also comprise one or more of the following contaminants: CO, NOₓ, SOₓ and HCl. The bed material retains the heat of the combustion process and upon circulation of the bed material from the combustion chamber 12 to the pyrolysis chamber 2, via the transport zone 42, this heat is used in the pyrolysis process. Use of heat derived from the combustion process to pyrolyse the feedstock in the pyrolysis chamber 2 results in a temperature difference between the combustion chamber 12 and the pyrolysis chamber 2. Increasing the circulation rate of the bed material reduces the temperature difference between the combustion chamber 12 and the pyrolysis chamber 2, and thereby enables lower temperatures to be achieved in the pyrolysis chamber 2. The higher temperatures achieved are however below the temperatures where over-cracking occurs. Decreasing the circulation rate of the bed material increases the temperature difference between the combustion chamber 12 and the pyrolysis chamber 2, and thereby allows for higher combustion temperatures while maintaining low temperature in the pyrolysis chamber 2.

The first, second and third fluidisation gas inputs 6, 8 and 50 and combustion air inputs 18 and 20 may advantageously be used in combination with each other or in isolation from one another. The first, second and third fluidisation gas inputs 6, 8 and 50 and combustion air inputs 18 and 20 are used to control the temperature in the pyrolysis chamber 2 and combustion chamber 12. The fluidisation gas (preferably steam) from the first, second and third fluidisation gas inputs 6, 8 and 50 are used to control the flow rate of the bed material through the transport zone 42. In particular, the velocity of the fluidisation gas in the second region 46 of the transport zone 42 may be from 0.5 to 3 m/s, preferably from 0.5 to 2 m/s. The velocity of the fluidisation gas in the pyrolysis chamber 2 may be from 5 to 8.5 m/s, preferably from 5.5 to 7.5 m/s.

The first fluidisation gas input 6 transfer fluidisation gas into the upstream portion 48 of the second region 46 of the transport zone 42. The second fluidisation gas input 8 transfers fluidisation gas into downstream portion 47 of the second region 46 of the transport zone 42. The third fluidisation gas input 50 transfers fluidisation gas into the first region 44 of the transport zone 42. The fluidisation gas input 20 transfers fluidisation gas into the air chamber 36 of the combustion chamber 12. The bed material flows from the first region 44 to the second region 46. In the first region 44 fluidisation gas flows downwardly away from the combustion chamber 12. In the second region 46 fluidisation gas flows upwardly towards from the combustion chamber 12 and into the pyrolysis chamber 2. Fluidisation gas may be transferred into the pyrolysis chamber 2 to control the circulation rate of the bed material. The circulation rate of the bed material may by increased or decreased by altering the amount of fluidisation gas transferred into the transport zone 42 and/or the pyrolysis chamber 2.

The circulation rate of the bed material is decreased by adding more fluidisation gas into the downstream portion 47 of the second region 46 than the upstream portion 48 of the second region 46. Here the ratio of fluidisation gas added to the upstream portion 48 relative to the downstream portion 47 is 1:1-6, typically 1:1.5-4. The circulation rate of the bed material is increased by adding less fluidisation gas into the downstream portion 47 of the second region 46 than the upstream portion 48 of the second region 46. Here the ratio of fluidisation gas added to the upstream portion 48 relative to the downstream portion 47 is 1-6:1, typically 1.5-4:1. Alternatively, the circulation rate of the bed material is decreased by adding more fluidisation gas into the downstream portion 47 of the second region 46 and/or the pyrolysis chamber 2 than the upstream portion 48 of the second region 46. Here the ratio of fluidisation gas added to the upstream portion 48 relative to the downstream portion 47 and/or the pyrolysis chamber 2 is 1:1-6, typically 1:1.5-4. The circulation rate of the bed material is increased by adding less fluidisation gas into the downstream portion 47 of the second region 46 and/or the pyrolysis chamber 2 than the upstream portion 48 of the second region 46. Here the ratio of fluidisation gas added to the upstream portion 48 relative to the downstream portion 47 and/or the pyrolysis chamber is 1-6:1, typically 1.5-4:1. Fluidisation gas may also be transferred into the first region 44. The fluidised reactor system therefore allows different amounts of fluidisation gas to be added to the transport zone 42 and/or pyrolysis chamber 2 and thereby control the transfer rate during operation. Using the fluidisation gas to increase the flow rate of the hot bed material has the advantage that the temperature difference is reduced between the combustion chamber 12 and the pyrolysis chamber 2. The reduction in the temperature difference prevents or minimises side reactions and thereby increases the yield of the high value chemicals.

The flow rate of the fluidisation gas may be the same for each of the first, second and third fluidisation gas inputs 6, 8 and 50. Alternatively, the flow rate of the fluidisation gas may be different for one or more of the first, second and third fluidisation gas inputs 6, 8 and 50. Preferably the fluidisation gas from the first, second and third fluidisation gas inputs 6, 8 and 50 is derived from an external source.

The product gas (for example at a temperature of 750° C.) is preferably transferred from the pyrolysis chamber 2 to the gas cooler 62 via the product gas output 10. The product gas is then cooled (for example to a temperature of 500° C.) before being transferred to the particulate removal unit 58 to remove solid particulate (bed material as well as carbon containing ash) and subsequently transferred to the quench column 66. The removed solid particulate (such as ash) in the particulate removal unit 58 is sent to the combustion chamber 12 via the ash gas outlet 64. This is primarily done to combust the char content of the ash, resulting in carbon free ash which is transferred out of the combustion chamber 12 via the flue gas output 16. This reduces or eliminates the need to dispose of carbon containing ash which has high disposal costs. Furthermore, this reduces the need to handle carbon containing ash which is pyrophoric. The product gas is quenched within the quench column 66 using circulating oil at a temperature of 50to 90° C. at atmospheric pressures, typically 60 to 90° C., even more typically 60 to 80° C., or at higher temperatures, when higher pressures are applied. This is commonly known as “Hot Oil” quenching. The oil is used to quench the gas to a temperature just above the water dewpoint. Temperatures below 50° C. are not used as the oil becomes viscous and consequently harder to pump. The amount of oil used in the quench column 66 is regulated to avoid the temperature of the oil exceeding 200° C. The separated ash and tar from the quench column 66 are sent via the ash and tar output 68 to the combustion chamber 12. The separated ash and tar provide an energy source in the combustion chamber 12, which provides heat for the pyrolysis process via circulation of the bed material from the combustion chamber 12 into the pyrolysis chamber 2. This reduces or removes the need for external support fuel required for the pyrolysis process. The quenched product gas is then sent, via the quenched product gas output 70 of the quench column 66 to the wet electrostatic precipitator 72. The wet electrostatic precipitator 72 removes oil coated ash particulate in the product gas. This is achieved by spreading the gas into a uniform flow profile using a gas distribution system, and then applying a high voltage (40+kV) between spray electrodes to charge the particles and subsequently collecting the charged particles at collecting electrodes where the particles agglomerate and are flushed. The separated aerosol liquid comprising tar fractions are transferred, via the aerosol liquid output 74, to the combustion chamber 12. The separated tar provides an energy source in the combustion chamber 12, which provides heat for the pyrolysis process via circulation of the bed material from the combustion chamber 12 into the pyrolysis chamber 2. This reduces or removes the need for external support fuel required for the pyrolysis process. The de-aerosoled product gas is then transferred, via the de-aerosoled product gas output 76, to the absorption column 78. Preferably, the de-aerosoled product gas is introduced at one end of the column (i.e. the bottom part) and the scrubbing agent (for example oil) is introduced at the opposite end of the column (i.e. the top part). Contact between the up-flowing gas and the down flowing scrubbing agent can be enhanced by conventional means such as by spraying, using a packed column or a plate column. The scrubbing may occur through either a co-current mode or a counter-current mode to remove impurities, such as tar, from the gas. The absorption column 78 can be operated at temperatures of for example between 80 and 90° C., preferably 80° C. at atmospheric or slightly super atmospheric pressures, or at higher temperatures, when higher pressures are applied. When higher pressures are applied the absorption column 32 should be operated at a temperature of 220° C. or below, preferably 200° C. or below.

The purified product gas is then transferred from the absorption column 78 to the product recovery unit 24, via the product gas output 82. The spent scrubbing agent is then circulated to the stripper column 80 where the impurities/tars are desorbed from the scrubbing agent via a stripping agent in the stripping section 84. The stripping agent (for example hot air, steam, nitrogen, carbon dioxide, flue gas or mixtures thereof, preferably hot air) is introduced via inlet 88. The combustion air transferred into the combustion chamber 12 and used as a fluidisation gas may be transferred into the stripper unit 80 and then be transferred back into the combustion chamber 12.

The spent scrubbing agent is then circulated to the deaeration section 86 where the scrubbing liquid is deaeroated by a deaerating agent before being circulated out of the stripper column 80 back into the absorption column 78 to provide a further round of scrubbing. Deaerating the scrubbing agent prevents air ingress into the stripping agent and in-turn prevents air ingress via the absorption column into the product gas. The deaerating agent may for example be steam which is introduced into the deaeration section 86 via inlet 90. The stripper column 80 is operated at about 100° C. above the temperature of the absorption column 78, more generally between 70 and 120° C. above the temperature of the absorption column 78, when using the same pressures. At atmospheric pressures, the temperatures can be between 150 and 220° C. Instead of using higher temperatures, the stripper column 80 can be operated at lower pressures than the absorption column 78. Air from the stripper column 80 may be circulated into the combustion chamber 12 and used in the combustion process. The absorption/desorption process may be performed via a temperature swing process or a pressure swing process. A temperature swing process may be used to strip light tars absorbed in oil at lower pressures (0.3 barg to 0.4 barg). A pressure swing process may be used to strip light tars absorbed in oil at higher pressures.

The gas ash removed by the particulate removal unit 58 may be transferred to the combustion chamber 12. The product gas in the product recovery unit 24 is then sorted and isolated into the one or more product streams which are then transferred out of the product recovery unit 24 using the one or more outlets 28, 30 and 32. The hot flue gas (for example at a temperature of 850° C.) from the combustion chamber 12 is transferred to the gas cooler 92 to cool the flue gas (for example to a temperature of 180° C.) before being transferred to the gas filter 94 which removes ash from the flue gas.

The feedstock input 4 may comprise a feeding screw. Feeding screws often exhibit high operating temperatures which may result in melting of certain fractions of the feedstock, such as polymers, within the screw feed and subsequent blockage of the screw feed. Introducing the feedstock via fuel feeding at a sufficiently high rate reduces the temperature of the feeding screw. Preferably the fuel feeding rate expressed in velocity through the feeding screw is from 0.3 m/s to 1.0 m/s. The temperature of the feeding screw may also be reduced by leasing the screw and its closed casing through the air chamber towards the pyrolysis zone, with the 60 to 80° C. air cooling the outside of the casing. The temperature of the feeding screw may also be reduced through addition of water and/or ash to the feedstock. Alternatively, the feedstock may have sufficient water content if derived for example from biomass, and therefore no additional water need be added to the feedstock. The feedstock may comprise 5% to 30% of water by weight of the feedstock, preferably comprises from 5% to 15% of water by weight of the feedstock, more preferably from 5% to 10%. The feedstock may also comprise from 1% to 15 of ash by weight of the feedstock, pressure control valve may be used to ensure a constant operating pressure between the product recovery unit 24, the quench unit 54 and the absorption unit 56. This has the further advantage of compensating for the changing in pressure differential of the Cooler 62.

### EXAMPLES

Table 1 shows a list of high value chemicals obtained via the claimed method when using wood, biogenic waste (composed of two-thirds biogenic material) and plastic waste (composed of two-thirds plastic material). In particular, the pyrolysis process was carried out at 750° C. Table 1 also shows the high value chemicals obtained through conventional naphtha cracking as a comparative example. The amounts are reported on a dry and N₂/CO₂ free basis.

TABLE 1

| Component | | Biogenic | Plastic | |
|---|---|---|---|---|
| (wt %) | Wood | waste | waste | Naphtha |
| Hydrogen (H₂) | 14.0% | 8.0% | 2.0% | 1.0% |
| Methane (CH₄) | 30.0% | 24.0% | 20.0% | 15.0% |
| Ethylene (C₂H₄) | 16.0% | 30.0% | 31.0% | 32.0% |
| Propylene (C₃H₆) | 0.0% | 8.0% | 17.0% | 16.0% |
| C₄ olefins | 0.0% | 4.0% | 9.0% | 10.0% |
| C₅₊ olefins | 0.0% | 0.0% | 1.0% | 7.0% |
| Benzene (C₆H₆) | 7.0% | 11.0% | 11.0% | 7.0% |
| Toluene (C₇H₈) | 1.0% | 2.0% | 2.0% | 3.0% |
| Tar/fuel oil | 0.0% | 0.0% | 0.0% | 3.0% |
| Carbon monoxide | 30.0% | 9.0% | 2.0% | 0.1% |
| (CO) | | | | |
| Parafins | 2.0% | 4.0% | 5.0% | 5.0% |
| Coke | n.d. | n.d. | n.d. | 1.0% |

Tests determining the melting behavior of five types of pure plastic (polypropylene (PP), polyethylene (PE), polystyrene (PS), polycarbonate (PC) and polycarbonate acrylonitrile butadiene styrene (PC-ABS) along with electronic waste (eWaste) were performed. It was shown that these materials could start to melt at temperatures between 140 and 230° C. without becoming a low viscous liquid (see Table 2). This behavior could potentially result in plastic blockage inside a feeding screw which conventionally operate at high temperatures.

TABLE 2

| Phase | PP | PE | PS | PC | PC-ABS | eWaste |
|---|---|---|---|---|---|---|
| Start of | 173° C. | 134° C. | 148° C. | 215° C. | 215° C. | 173° C. |
| deformation | | | | | | |
| Melting | 194° C. | 139° C. | 173° C. | 231° C. | 231° C. | 215° C. |
| behaviour | | | | | | |
| Liquid | 231° C. | 194° C. | 231° C. | 281° C. | n.d. | n.d. |
| plastic | | | | | | |

In contrast to Table 2, no feeding issues were observed with biomass, biogenic waste or plastic waste. This is at least partially attributed to the ash and moisture content of these materials. Table 3 shows a typical ash and moisture content of wood, biogenic waste and plastic waste. Tests showed that addition of both ash and moisture to pure plastics resulted in less problems associated with feeding. In particular, moisture lowered the temperature of the feedstock in the screw and ash provided a protecting coating on the sticky particles to reduce agglomeration of particles within the feeding screw.

TABLE 3

| | | Biogenic | Plastic |
|---|---|---|---|
| Proximate analysis | Wood | waste | waste |
| Moisture content | 11.0 | 2.3 | 0.2 |
| (wt % as received) | | | |
| Ash content 550° C. | 0.6 | 13.8 | 10.8 |
| (wt % dry basis) | | | |
| Ash content 815° C. | 0.5 | 12.8 | 9.8 |
| (wt % dry basis) | | | |
| Volatile matter | 83.0 | 76.9 | 85.2 |
| (wt % dry basis) | | | |

Tables 4 and 5 show a list of high value chemicals obtained via an alternative method when using refuse derived fuel. It was found that operating the pyrolysis process from 700 to 800° C. provided large amounts of high value chemicals in the product gas. The amounts are reported on a dry and N₂/CO₂ free basis.

TABLE 4

| Component (vol %) | 749° C. | 768° C. | 796° C. | 823° C. | 863° C. |
|---|---|---|---|---|---|
| Hydrogen (H₂) | 35.3 | 32.3 | 36.7 | 38.0 | 39.5 |
| Carbon monoxide (CO) | 27.9 | 32.7 | 32.7 | 31.3 | 33.5 |
| Methane (CH₄) | 17.4 | 17.2 | 18.1 | 16.7 | 16.6 |
| Acetylene (C₂H₂) | 0.4 | 0.6 | 0.6 | 0.8 | 1.2 |
| Ethylene (C₂H₄) | 13.9 | 14.2 | 9.9 | 12.0 | 8.8 |
| Ethane (C₂H₆) | 1.7 | 1.2 | 0.8 | 0.6 | 0.3 |
| Propylene (C₃H₆) | 3.0 | 1.7 | 1.1 | 0.6 | 0.1 |
| Propane (C₃H₈) | 0.1 | 0.0 | 0.0 | 0.0 | 0.0 |
| Isobutene (iso-C₄H₈) | 0.2 | 0.1 | 0.1 | 0.0 | 0.0 |

TABLE 5

| Component (g/Nm³) | 749° C. | 768° C. | 796° C. | 823° C. | 863° C. |
|---|---|---|---|---|---|
| Benzene (C₆H₆) | 3.9 | 35.0 | 33.0 | 15.1 | 79.6 |
| Toluene (C₇H₈) | 5.2 | 18.2 | 7.0 | 12.1 | 6.3 |
| Styrene (C₈H₈) | 21.7 | 22.3 | 9.2 | 13.7 | 6.7 |
| Ethylbenzene (C₈H₁₀) | 0.7 | 0.4 | n.d. | 0.2 | 0.1 |
| m-Xylene (C₁₀H₈) | 0.9 | 1.0 | 0.3 | 0.4 | 0.1 |
| p-Xylene (C₁₀H₈) | 0.5 | 0.5 | n.d. | 0.2 | n.d. |

According to the method of the current invention tests were performed on a prefabricated mixture of 26 wt. % biomass, 32 wt. % polypropylene and 42 wt. % polyethylene showing a similar result. As seen in Table 6 the olefine yields are highest at around 750° C., with benzene, toluene and tars resulting from over-cracking increasing at higher temperatures. The carbon yields towards specific components, including the carbon yield towards flue gas, are also shown in Table 6.

TABLE 6

| Component (%) | 701° C. | 743° C. | 792° C. |
|---|---|---|---|
| Carbon monoxide (CO) | 6.1 | 6.6 | 6.6 |
| Carbon dioxide (CO₂) | 1.9 | 2.3 | 3.2 |
| Methane (CH₄) | 8 | 11.3 | 13.7 |
| Acetylene (C₂H₂) | 0.2 | 0.3 | 0.6 |
| Ethylene (C₂H₄) | 16.5 | 21.3 | 20.1 |
| Ethane (C₂H₆) | 1.8 | 1.9 | 1.4 |
| Propylene (C₃H₆) | 10 | 8.9 | 3.2 |
| Propane (C₃H₈) | 0.4 | 0.3 | 0.1 |
| C₄ | 5.7 | 5.2 | 2.2 |
| C₅ | 0.5 | 0.4 | 0.2 |
| Benzene (C₆H₆) | 8.3 | 13.8 | 16 |
| Toluene (C₇H₈) | 3.3 | 3.7 | 3.1 |
| Tars | 8 | 10 | 13.1 |
| Flue gas | 22.7 | 7.6 | 11.2 |

It was surprising found that operating the pyrolysis process between 700 to 800° C. improved the operability of the quench unit downstream the pyrolysis chamber 1. Table 7 shows the tar distribution following cracking of biomass or refuse derived fuel at 750° C. or 850° C. based on: class 1 (benzene to indene), class 2 (naphthalene to fluorene), class 3 (phenanthrene to fluoranthene), class 4 (pyrene to benzo(k)fluoranthene and class 5 (benzolpyrene to coronene) with tar dewpoint indication (° C.) based on 10 g/Nm³ tar as well as an average viscosity (cP) provided per class. Although more tars are formed at lower temperatures (i.e. 750° C.), this proved to be beneficial for the quench unit as the tars are light tar fractions (i.e. lower molecular weight) and as such have a lower tar dewpoint as well as a lower viscosity. The lower tar dewpoint reduces the risk of fouling between the pyrolysis chamber and the quench unit, whilst the lower viscosity reduces the risk of fouling within the quench unit itself.

Operating the pyrolysis chamber 2 at lower temperatures results in large quantities of light tar fractions and consequently the tar load in the absorption unit 56 increases bringing the stripper process 84 closer to the lower explosion limits in case the combustion air inputs 18 and 20 are used for stripping. The tars are absorbed from the gas into a scrubbing agent (such as oil) within the absorption column 78. The saturated oil is then sent to the stripper column 80 where a stripping agent is used to remove the tars. The stripping agent may be combustion air to combustion chamber 12. The stripping agent ensures that the method operates below 50% of the Lower Explosion Limit (LEL) of the tars in the air. This is achieved through use of the primary and secondary air for stripping. The LEL has been determined as 37 g/Nm³. The combustion air may be reintroduced back into the combustion chamber 12, for example partially in the freeboard zone above the combustion bed 34. This lowers the temperature of the combustion bed 34 in the combustion zone 12 as part of the light tar tars are combusted above the fluidised bed zone 34 and not within the fluidised bed zone 34. Alternatively, water may be injected into the fluidised bed zone 34 to lower the temperature of the fluidised bed zone 34. The water may be wastewater derived from water condensation within the product recovery unit 24.

TABLE 7

| | Tar distribution (%) | | | | |
|---|---|---|---|---|---|
| | Class 1 | Class 2 | Class 3 | Class 4 | Class 5 |
| | <25° C. | 61-112° C. | 132-167° C. | 176-224° C. | >234° C. |
| | 2.4 cP | 33.4 cP | 73.8 cP | 117.3 cP | 441.7 cP |
| Biomass at 750° C. | 73.3 | 18.9 | 5.0 | 2.0 | 0.7 |
| Biomass at 850° C. | 74.2 | 17.8 | 5.2 | 2.2 | 0.8 |
| RDF at 750° C. | 71.8 | 19.5 | 5.1 | 3.0 | 0.6 |
| RDF at 850° C. | 49.6 | 25.8 | 11.2 | 7.4 | 6.0 |

An increase in viscosity of the liquid in the quench system proved to be problematic. First, high viscosity tars were generated at ≥800° C. were collected in the quench unit. Second, high concentrations of ash fraction remained in the gas having been processed in the particulate removal unit 58 (i.e. cyclone). In particular high loads of fines in the product gas, e.g. resulting from a high calcium content in the feedstock, resulted in increased viscosities. Furthermore, it was also found that the ash particles tendered to accumulate within the pyrolysis chamber.

Therefore, a cyclone was developed for the purpose of allowing sufficient time for the ash particles to agglomerate within the cyclone to aid in separation of the ash particles from the depolymerised polymer product gas. The cyclone therefore is smaller than conventional cyclones to have more interaction between the particles, though taller to create sufficient residence time for particles to agglomerate. Table 8 shows the particle size distribution of ash remaining in the depolymerised polymer product gas in mg/Nm³ (milligrams per normal cubic meter) as a function of the inlet particle size distribution.

TABLE 8

| | | | Outlet | | | |
|---|---|---|---|---|---|---|
| Particle size | | | 109 | 139 | 580 | 779 |
| distribution | | Inlet | mg/Nm³ | mg/Nm³ | mg/Nm³ | mg/Nm³ |
| <0.01 | μm | 0.0 | 0.0 | 0.0 | 0.0 | 0.0 |
| <0.05 | μm | 0.5 | 0.0 | 0.0 | 1.0 | 0.0 |
| <0.1 | μm | 1.0 | 2.6 | 0.0 | 5.0 | 0.5 |
| <0.5 | μm | 3.5 | 30.0 | 50.0 | 69.0 | 66.0 |
| <1 | μm | 5.5 | 48.0 | 67.5 | 78.0 | 77.0 |
| <5 | μm | 16.0 | 92.0 | 100.0 | 100.0 | 100.0 |
| <10 | μm | 32.0 | 100.0 | 100.0 | 100.0 | 100.0 |
| <50 | μm | 90.0 | 100.0 | 100.0 | 100.0 | 100.0 |
| <100 | μm | 99.0 | 100.0 | 100.0 | 100.0 | 100.0 |
| <500 | μm | 100.0 | 100.0 | 100.0 | 100.0 | 100.0 |

Table 9 shows the sand flow and sand to fuel ratio as a function of the fluidisation gas velocity through the transport zone 42. The operating temperature of the pyrolysis chamber 1 may be altered by adding more fluidisation gas below the transport zone 42 and less above or into the transport zone 42. This redistribution of fluidisation gas changes the temperature difference between the pyrolysis chamber 2 and the combustor chamber 12, as the flow of fluidisation gas (i.e. sand) through the transport zone 42 can be increased without having to mechanically modify the size of the transport zone 42. By increasing velocity this can be increased considerably.

TABLE 9

| | Fluidisation velocity (m/s) | | | | |
|---|---|---|---|---|---|
| Sand transport | 3.1 | 4.3 | 5.4 | 6.6 | 7.8 |
| Sand flow (kg/hr) | 180 | 194 | 212 | 245 | 289 |
| Sand to fuel ratio (—) | 36 | 39 | 42 | 49 | 58 |

The amount of contaminants within the product gas can be reduced by modifying the operating conditions of systems upstream the product recovery unit 24. It was found that oxygen can ingress into the product gas either via the transport of hot bed material (i.e. sand) from the combustion chamber 12 into the pyrolysis chamber 2 or via the ingress of air into the scrubbing agent (i.e. oil) whist being stripped with a stripping agent to remove tar fractions. Solubilities of contaminant gases within the stripped scrubbing oil are low, as shown in Table 10. The presence of carbon dioxide and nitrogen are not of concern as these gases are already present in the product gas in significant levels. The amount of oxygen however should be kept low (i.e. at ppb levels). Prevention or reduction of the ingress of oxygen into the scrubbing oil is achieved through use of the deaeration section 86 of the stripper column 80. In addition, steam may be injected at the top of the transport zone 42 to strip the circulating hot bed material (i.e. sand) from flue gases. This not only lowers the amount of oxygen ingress into the product gas within the pyrolysis chamber 2, but also lowers the amount of NO. Oxygen and NO for example, can react to form solid N₂O₃ and N₂O₄. These solids have the tendency to accumulate and may react with ammonia forming explosive chemical ammonium nitrates. In addition, N₂O₃ has been shown in industry to react with ethylene and propylene violently at 25° C. The steam can also be used for the dilution of the product gas in the pyrolysis chamber 2.

TABLE 10
shows the solubility of contaminant gases collected in the
stripped scrubbing oil as a function of oil temperature.

| | Solubility (cm³/g) | | | | | | | | |
|---|---|---|---|---|---|---|---|---|---|
| | 0° C. | 25° C. | 50° C. | 75° C. | 100° C. | 125° C. | 150° C. | 175° C. | 200° C. |
| Carbon | 2.34 | 1.92 | 1.57 | 1.24 | 1.00 | 0.80 | 0.67 | 0.58 | 0.54 |
| dioxide (CO₂) | | | | | | | | | |
| Oxygen (O₂) | 0.27 | 0.25 | 0.24 | 0.24 | 0.23 | 0.22 | 0.21 | 0.20 | 0.20 |
| Nitrogen (N₂) | 0.15 | 0.16 | 0.17 | 0.18 | 0.19 | 0.20 | 0.21 | 0.22 | 0.23 |

Unlike conventional naphtha cracking which requires high steam dilution, the present invention only requires low steam dilution. Table 11 shows that the driving factor in ethylene and propylene formation is the temperature at which the reaction is performed and not the steam to carbon ratio. Taking the velocity of the fluidisation gas in the transport zone to be from 0.5 to 3 m/s, then the order of the steam-to-carbon ratio would typically be from 0.05-0.10 at the low end and from 0.75-1.50 at the high end.

TABLE 11
shows the carbon yield of different components at different
cracking temperatures and steam-to-carbon (StC) ratios for
mixtures comprising wood, polypropylene and polyethylene.

| | 26% wood + 32% | | | 34% wood + 28% | | |
|---|---|---|---|---|---|---|
| Component | PP + 42% PE (StC~1.5) | | | PP + 38% PE (T~750° C.) | | |
| (vol %) | 701° C. | 743° C. | 792° C. | StC 1.1 | StC 1.6 | StC 2.0 |
| Carbon | 6.1 | 6.6 | 6.6 | 7.1 | 7.2 | 6.5 |
| monoxide | | | | | | |
| (CO) | | | | | | |
| Carbon | 1.9 | 2.3 | 3.2 | 1.9 | 2.1 | 2.4 |
| dioxide (CO₂) | | | | | | |
| Methane | 8.0 | 11.3 | 13.7 | 11.8 | 10.0 | 10.0 |
| (CH₄) | | | | | | |
| Acetylene | 0.2 | 0.3 | 0.6 | 0.3 | 0.3 | 0.4 |
| (C₂H₂) | | | | | | |
| Ethylene | 16.5 | 21.3 | 20.1 | 17.3 | 15.3 | 16.8 |
| (C₂H₄) | | | | | | |
| Ethane | 1.8 | 1.9 | 1.4 | 1.8 | 1.5 | 1.7 |
| (C₂H₆) | | | | | | |
| Propylene | 10.0 | 8.9 | 3.2 | 5.0 | 4.1 | 6.2 |
| (C₃H₆) | | | | | | |
| Propane | 0.4 | 0.3 | 0.1 | 0.2 | 0.1 | 0.2 |
| (C₃H₈) | | | | | | |
| C₄ | 5.7 | 5.2 | 2.2 | 3.1 | 2.6 | 4.1 |
| C₅ | 0.8 | 0.3 | 0.0 | 0.0 | 0.0 | 0.1 |
| Benzene | 8.3 | 13.8 | 16.0 | 14.0 | 9.7 | 13.8 |
| (C₆H₆) | | | | | | |
| Toluene | 3.3 | 3.7 | 3.1 | 3.4 | 2.3 | 3.5 |
| (C₇H₈) | | | | | | |
| Tars | 8.0 | 10.1 | 13.1 | 10.4 | 7.7 | 11.3 |
| Flue gas | 22.7 | 7.6 | 11.2 | 21.3 | 25.3 | 22.3 |

1. Method for producing high value chemicals from feedstock, wherein the feedstock is waste material or comprises waste material the method comprising:
(a) providing a fluidised reactor system comprising a pyrolysis chamber and combustion chamber, and
(b) inputting the feedstock into the pyrolysis chamber and executing a pyrolysis process at a temperature in the range of from 650 to 850° C. to obtain a product gas comprising high value chemicals.

2. The method according to claim 1, wherein the pyrolysis process is executed at a temperature in the range of from 700 to 800° C.

3. The method according to claim 1, further comprising transferring the product gas from the pyrolysis chamber to a tar removal system to remove one or more tar fractions from the product gas

4. The method according to claim 3, wherein one or more of the following applies:
the product gas transferred to the tar removal system comprises class 3-5 heavy tar fractions, the content of class 3-4 being greater than the content of class 5 by weight of the total class 3-5 heavy tar fractions;
the product gas transferred to the tar removal system comprises by weight of the total class 3-5 heavy tar fractions: (i) from 50 to 80% class 3 heavy tars, (ii) from 10 to 40% class 4 heavy tars and (iii) 10% or less class 5 heavy tars;
the product gas transferred to the tar removal system comprises from 20 to 30 g/Nm³ of class 3-5 heavy tars;
the product gas transferred to the tar removal system comprises a ratio of dust to class 3-5 heavy tars from 1:99 to 10:90;
the product gas transferred to the tar removal system comprises from 0 to 2 g/Nm³ of dust.

5.-8. (canceled)

9. The method according to claim 1, wherein one or more of the following applies:
the waste material is municipal solid waste;
the waste material is biomass, biomass rich refuse-derived fuel, plastic rich refuse-derived fuel and plastics or combinations thereof;
the waste material comprises plastic;
the waste material comprises 30 to 100% of plastic by weight of the waste material;
the feedstock comprises 5 to 30% water originating from the waste material and/or separately added to the feedstock;
the anthropogenic carbon present in the waste material is from 40 to 100% of the carbon in the waste material.

10.-14. (canceled)

15. The method according to claim 1, wherein the high value chemicals in the product gas are olefins and/or monocyclic aromatic compounds, wherein the olefins may be selected from ethylene, propylene, C₄ olefins, C₅ olefins, or combinations thereof and/or the monocyclic aromatic compounds may be selected from benzene, toluene, xylene, styrene or combinations thereof.

16. (canceled)

17. The method according to claim 1, further comprising transferring the product gas into a product recovery unit and isolating the high value chemicals, optionally wherein the product gas is transferred from the pyrolysis chamber to a tar removal system prior to being subjected to step to remove one or more tar fractions from the product gas.

18. (canceled)

19. The method according to claim 17, wherein:
the tar removal system comprises an absorption unit to remove light tar fractions from the product gas, such as light tar fractions, and dust, optionally wherein a portion of the light tar fractions is transferred to the combustion chamber; and/or
the tar removal system comprises a quench unit to remove heavy tar fractions from the product gas, optionally
wherein the product gas is quenched via a quenching medium, typically oil, at a temperature in the range of from 50 to 95° C., and
wherein the spent quenching medium obtained after the quenching has a viscosity in the range of from 40 to 200 cP, preferably from 80 to 160 cP, optionally
wherein a portion of the heavy tar fractions is transferred to the combustion chamber.

20.-24. (canceled)

25. The method according to claim 1, wherein in the combustion chamber a combustion process is executed at a temperature in the range of from 30 to 130° C. higher than the pyrolysis process.

26. The method according to claim 1, further comprising circulating bed material from the combustion chamber to the pyrolysis chamber via a transport zone, wherein the pyrolysis process and the combustion process are executed in the bed material, optionally wherein one or more of the following applies:
upon circulating the bed material sufficient heat is transferred from the combustion chamber to the pyrolysis chamber to execute the pyrolysis process;
the temperature difference between the combustion chamber and the pyrolysis chamber is increased by decreasing the circulation rate of the bed material, and wherein the temperature difference between the combustion chamber and the pyrolysis chamber is decreased by increasing the circulation rate of the bed material;
wherein the circulation rate of the bed material is from 10 to 100 kg bed material circulated per kg of feedstock;
fluidisation gas is transferred into the transport zone to control the circulation rate of the bed material, optionally at more than one region,
wherein the temperature difference between the combustion chamber and the pyrolysis chamber is increased or decreased by changing the ratio of fluidisation gas transferred into a first region of the transport zone relative to a second region of the transport zone;
the transport zone comprises a first region to allow the downflow of bed material from the combustion chamber and a second region to allow the upflow of bed material to the pyrolysis chamber optionally
wherein the fluidisation gas is transferred into an upstream portion of the second region and into a downstream portion of the second region.

27.-34. (canceled)

35. The method according to claim 26, wherein the fluidisation gas is transferred into the transport zone with a velocity 0.5 to 3 m/s, or wherein the velocity of the fluidisation gas in the upstream portion and/or downstream portion is from 0.5 to 3 m/s.

36. (canceled)

37. The method according to claim 1, wherein fluidisation gas is transferred into the pyrolysis chamber, typically from a product recovery unit of the fluidised reactor system, to control the circulation rate of the bed material, wherein the velocity of the fluidisation gas in the pyrolysis chamber may be from 5 to 8.5 m/s.

38. (canceled)

39. (canceled)

40. The method according to claim 1, further comprising isolating tail gas or off gas from the product gas, wherein at least a portion of the tail gas or off gas may be transferred to the combustion chamber, and/or
wherein at least a portion of the tail gas or off gas is used for the production of chemicals.

41. (canceled)

42. (canceled)

43. The method according to claim 1, further comprising transferring the product gas from the pyrolysis chamber to a particulate removal unit, such as a cyclone, prior to being transferred to the a removal system to remove dust from the product gas.

44. The method for producing high value chemicals from feedstock, wherein the feedstock is waste material or comprises waste material, the method comprising:
(a) providing a fluidised reactor system comprising a pyrolysis chamber and combustion chamber,
(b) inputting the feedstock into the pyrolysis chamber and executing a pyrolysis process at a temperature in the range of from 650 to 850° C. to obtain a product gas comprising high value chemicals;
(c) transferring the product gas from the pyrolysis chamber to a particulate removal unit to remove dust from the product gas;
(d) transferring the product gas from the particulate removal unit to a tar removal system, comprising a quench unit, to remove heavy tar fractions from the product gas,
wherein the product gas transferred to the tar removal system comprises from 0 to 2 g/Nm³ of dust and from 20 to 30 g/Nm³ of class 3-5 heavy tars, including (i) from 50 to 80% class 3 heavy tars and (ii) from 10 to 40% class 4 heavy tars and (iii) 10% or less class 5 heavy tars, based on total weight of the class 3-5 heavy tars.
